(19) United States
(12) Patent Application Publication
(10) Pub. No.: US 2003/0075971 A1
(43) Pub. Date: Apr. 24, 2003

(54) Wheel cap for clamping on a wheel rim

(76) Inventor: Alwin Geisel, Ruti (CH)

Correspondence Address: BREINER & BREINER, 115 NORTH HENRY STREET, ALEXANDRIA, VA, 22314

(21) Appl. No.: 10/149,703

(22) PCT Filed: Dec. 13, 2000
(86) PCT No.: PCT/CH00/00663

(30) Foreign Application Priority Data
Dec. 16, 1999 (DE) 99125072.1

(51) Int. Cl. B60B 7/12

(52) U.S. Cl. 301/37.33

(57) ABSTRACT

A hubcap, i.e., a wheel cover, to be clamped on a wheel rim, includes a spring (1) configured in the form of an at least a nearly regular polygon. At least a portion of the vertices (9) or vertex zones of the polygonal spring (1) is affixed to radially elastic supports (14) of the hubcap (11) for the purpose of keeping in snap-in manner the hubcap in an illustratively annular recess against the wheel rim. The vertices or vertex zones (9) rest in rotatable manner on the supports (14) and/or the polygonal spring is discontinuous at least at a portion of the vertices or vertex zones, in order that, when an external force acts radially on the vertices or vertex zones, there may be, besides the resulting radial inward displacement of the polygonal spring (1), also an additional displacement of the polygonal spring, i.e., of the individual segments between the vertices or vertex zones of the polygonal spring.

The present invention relates to a wheel cap, hereafter “hubcap”, to be clamped on a wheel rim, in particular of passenger motor vehicles, as defined in the preamble of claim 1.

Hubcaps are known from German Application Nos. 44 08 480 A1 and 26 22 908 A1 that are fitted with a circular annular spring firmly held in supports connected to the hubcap. As the hubcap is clamped into place, the supports are bent radially inward against the opposing force of said annular spring until index beaks fitted on the supports snap into a circumferential groove in the wheel rim. Thus the required radial retaining force is generated by a welded annular spring made of spring-steel wire. Such hubcaps incur the drawback that rather large opposing forces exerted by the annular spring must be overcome when the hubcaps are being put in place. These large opposing forces are caused by the need to use a comparatively stiff annular spring to attain sufficiently good and firm affixation of the hubcap to the wheel rim.

The following four conditions must be met to optimally affix the hubcap to the wheel rim:

1. When the hubcap is off the rim, good assembly of hubcap into the rim and security against the supports not breaking during assembly require that the annular spring not force the supports excessively far outward.

2. The removal of the hubcap from the rim takes place at a specified force of removal which assures that the hubcap does not come off the rim during vehicle use. Factors to be considered in this respect for instance are vibrations, centrifugal forces and external effects. Nevertheless the hubcap as a rule is taken off manually without resort to tools.

3. In the assembled state, the radial force still must be sufficient to generate as high as possible a torque which is applied to the hubcap to rotate it in the rim. This feature is required to preclude damaging the valve projecting through the apertures and abrading the index beaks. In particular the hubcap may not rotate even when impulsive wheel motions take place in the case of antilock braking systems (ABS) and anti-spin regulation systems (ASR).

4. The manufacturing tolerances of rim, hubcap and annular spring may not degrade hubcap functionality.

Patent documents DE 29 37 083 B1; DE 29 43 137 C2; DE 30 39 219 A1 and DE 33 15 342 C2 describe annular springs which allow overcoming their opposing forces during hubcap clamping in that their radially outward path is limited by stops and in that the springs are radially prestressed when resting against the stops.

Being prestressed, the hubcap will be clamped on the rim with comparatively little force while on account of the prestressing bias it shall still be forcefully retained in the rim. However, in the unassembled state, the bias must be absorbed by the hubcap. In order to prevent the unassembled hubcap from deforming, it must be strongly reinforced. This requirement entails adding to the hubcap weight and increasing tool and parts costs.

Further variants to solving this problem are disclosed in U.S. Pat. No. 4,740,038 and Japanese Application 3-169 702A. These documents propose tangentially prestressing the annular spring in that the bending stress of a radially inwardly-shaped bend is kept in place by a tangential separate stressing bail opposing enlarging the spring diameter. This solution offers the same features as does the radially prestressed spring and offers an advantage over the latter that, in its free condition, no radial forces are exerted on the hubcap. On the other hand, because of the additional stressing bail and its assembling costs to the spring, this variant is very expensive. Moreover, the radial action of the annular spring is centrally asymmetric on account of the tangential friction in the supports, instead the action is unilateral, and as a result the circular motion of the hubcap relative to the rim is adversely affected.

Accordingly, the object of the present intention is to create a hubcap which can be assembled to, and disassembled from, a wheel rim at high torque and low exertion of force and which is not subjected in its assembled state to radial bias forces.

German Patent 195 01 808 offers a solution to this problem by using a hubcap fitted with an annular spring comprising an inner wire spring in turn including outwardly bent bail segments along its circumference, said segments rotatably resting on supports, as a result of which and when a force is radially applied from the outside, there is, in addition to the radially inward motion, also axial displacement of the wire spring.

However, the wire spring proposed in German Patent 195 01 808 is relatively costly in money and elaborate in manufacture, and therefore another object of the present invention is to create a hubcap fitted with an enclosing spring in the sense of a continuation of German Patent 195 01 808 that is simpler and more economical to manufacture and in substantially polygonal rather than circular shape.

These goals of the invention are attained by the features of claim 1.

The hubcap of the invention to be clamped onto a wheel rim again comprises a spring that, contrary to the design proposed in German Patent 195 01 808, assumes as much as possible an at least regular polygonal shape and is called hereafter a “polygonal spring”. The vertices or vertex zones of the polygonal spring are attached to radially resilient supports of the hubcap to be kept in a snap-in manner in an annular recess at the wheel rim. The supports' vertices or vertex zones either are rotatably supported and/or the polygonal spring are in distinct segments at least at some of the vertices or vertex zones in such a manner that when an external force is applied radially to the vertices or vertex zones, there is, in addition to the resultant radially inward displacement of the polygonal spring, a further axial displacement of the spring, i.e. of the individual spring segments situated between the vertices.

Again the hubcap of the invention comprises a polygonal spring which also corresponds to that of German Patent 195 01 808 and can be also called a “two-phase spring” and hence offers all the advantages of the spring of said German Patent.

In an embodiment variation of the invention, the polygonal spring's vertices or vertex zones rest in a rotatable manner on the supports whereby, during the clamping of the hubcap on the wheel rim, the polygonal spring not only is being within one plane but also is able to move axially. In this way, upon radial excursion of the polygonal spring, the preferably at least nearly straight connecting parts can be bent elastically in an oblique-to-perpendicular manner out of the plane of said spring, the wire in this process moving torsionally around its axis. Because of this additional bending and torsional motion, a sufficiently high torque of rotation is generated that the hubcap cannot be rotated even in the event of impulsive wheel motions.

In another embodiment mode of the polygonal spring of the invention, same is discontinuous at a minimum of one, but preferably several or all vertices or vertex zones in a manner that the spring consists substantially of the individual wire segments situated between those of the vertices or vertex zones that each are affixed by their ends to the supports, i.e., are received in recesses of the supports.

Compared to known hubcaps having radially prestressed polygonal springs, the hubcap of the invention offers a substantially simpler design because this latter hubcap is not required to absorb any bias forces when in its assembled state. Accordingly, the hubcap of the invention lacks any additional reinforcing ribs and thereby is lighter.

Compared to known hubcaps wherein the polygonal spring is tangentially prestressed, costs are saved again by the invention's elimination of the additional tightening bail. Moreover, the novel spring configuration offers a centrally symmetrical radial force rather than being one-sided, and consequently the hubcap's rotation relative to the rim is improved.

Again comparison of the polygonal spring used in the present invention with that of German Patent 195 01 808 shows both a simpler design and a further substantial advantage in that relative to a conventional circular spring, the same radial force can be attained by a spring of the invention of substantially lesser wire thickness, thereby at lower material costs and weight.

German Patent 26 22 908 also discloses a polygonal spring fitted with straight connecting elements. This spring is fitted with radially outward bends that do not act on the supports but directly engage the rim groove. Furthermore, the radial bends are so guided in the support that they are precluded from any torsional motion, as a result of which axial spring excursion is suppressed.

Moreover, the polygonal spring of the invention, and also the polygonal configuration constituted by the individual segments, not only may be used for hubcaps, but also are applicable wherever a constant-force spring behavior is required in the radial direction, for example as a supporting spring for radial seals, electrical radial contacts, radial wear compensation, etc.

The invention is elucidated in an illustrative manner below and in relation to the attached Figures.

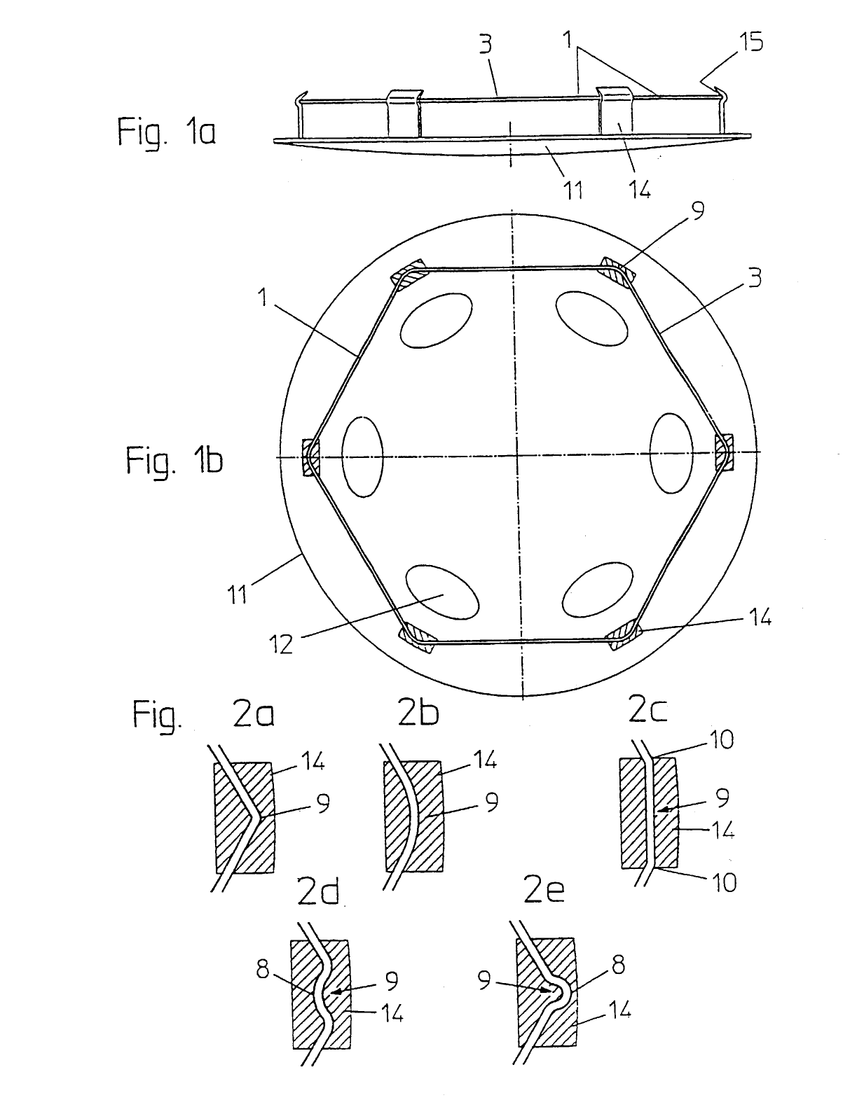

FIG.1a is a sideview of a hubcap of the invention with its polygonal spring;

FIG. 1b is a topview of the hubcap of FIG. 1a with an integrated polygonal spring;

FIGS. 2a-2e schematically show differently designed vertex zones of a polygonal spring of the invention correspondingly resting in supports;

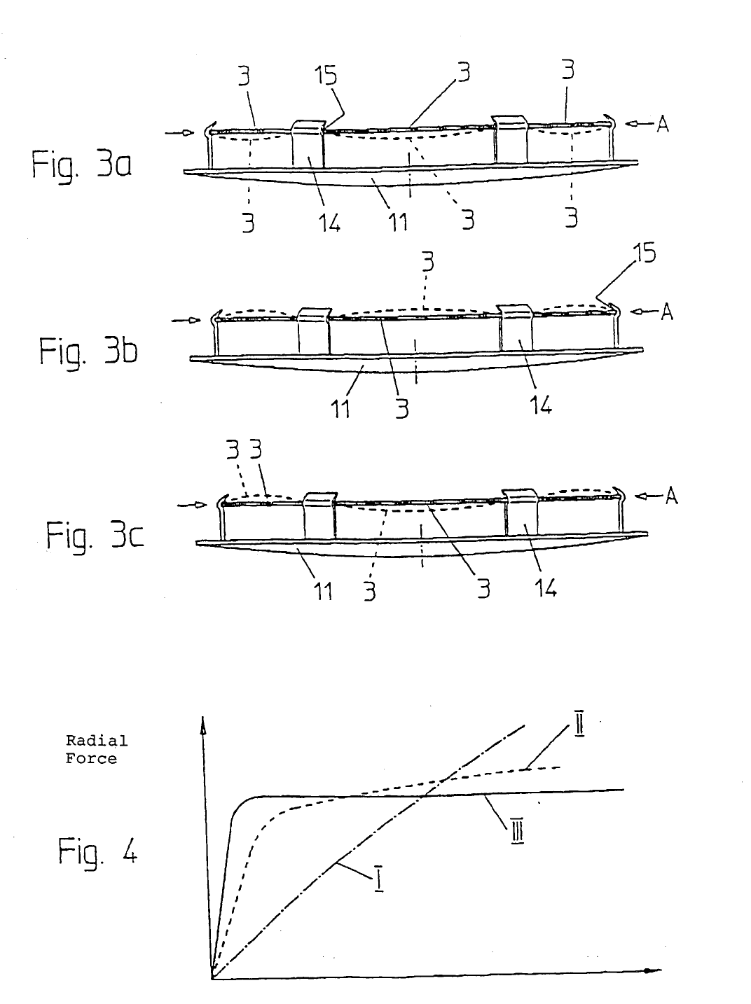

FIGS. 3a-3c schematically show possible directions of excursion of the polygonal spring of the invention;

FIG. 4 is a plot of the spring force as a function of spring excursion both for an installed polygonal spring of the invention and for a closed spring of the state of the art;

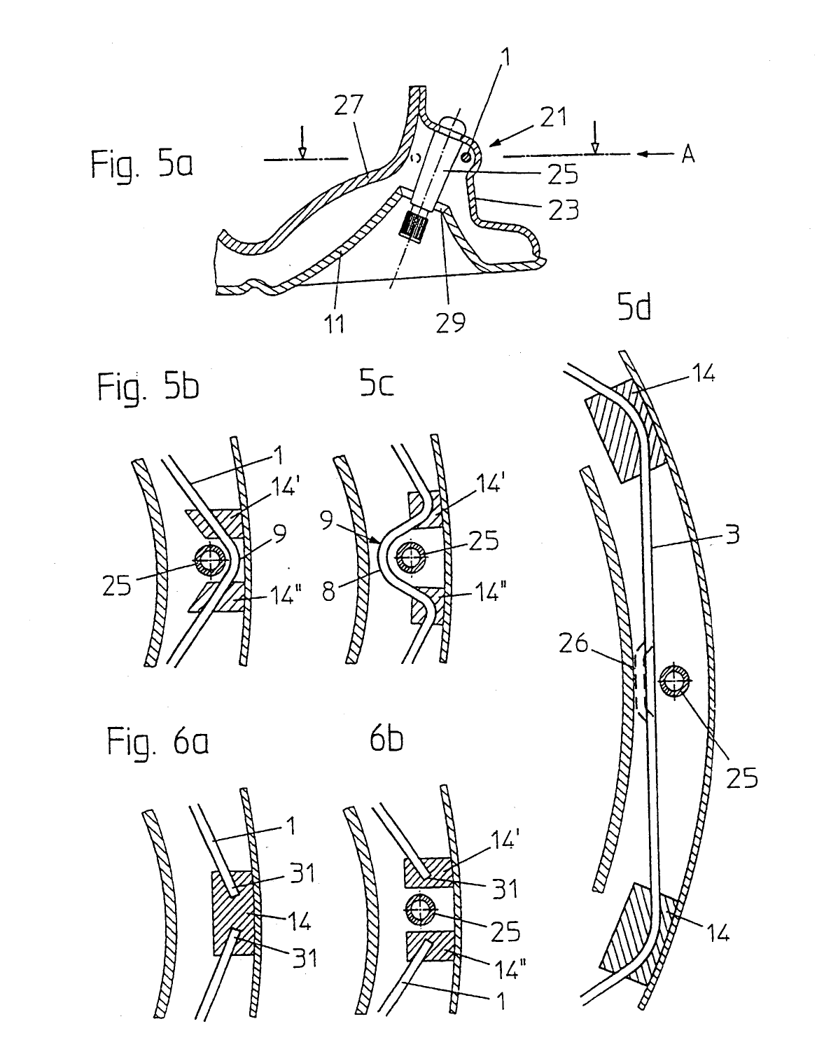

FIG. 5a is a cross-section of the rim's valve zone;

FIGS. 5b and 5c are top views of vertex zones with valve;

FIG. 5d is a top view of a hubcap comprising the valve configured between two vertex zones;

FIGS. 6a and 6b are top views of a vertex zone, i.e., a connection site, for an open, that is not closed, polygonal spring,

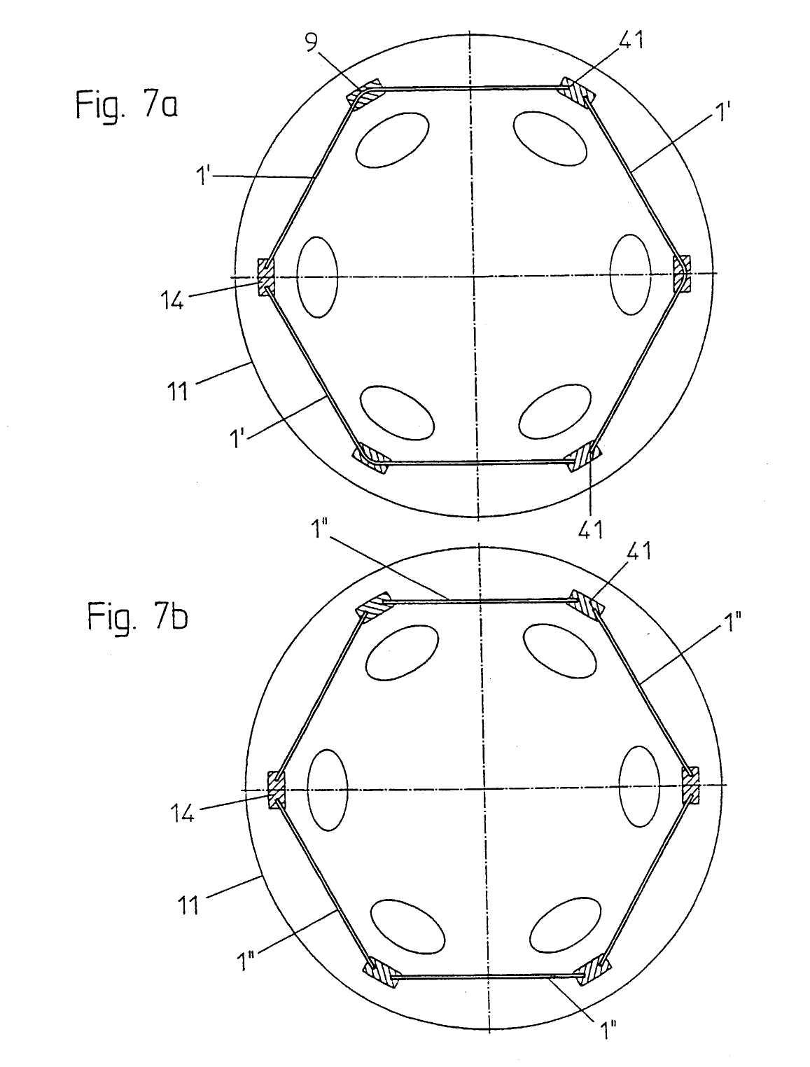

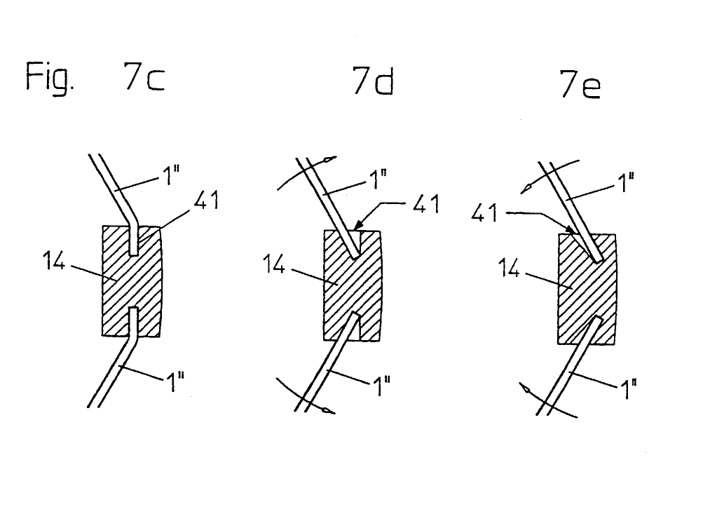

FIGS. 7a and 7b are top views of another embodiment of a hubcap of the invention with the polygonal spring consisting of several segments or bent rods; and

FIGS. 7c-e show vertex zones of the elements of FIGS. 7a and 7b.

FIGS. 1a and 1b are, respectively, a side view and a top view of a hubcap of the invention, the latter view very clearly showing the internal polygonal spring 1. The polygonal spring consists of a regular polygon, for example an equilateral hexagon as shown in FIG. 1b. Preferably, the number of vertices are between three and ten. The connecting elements between the vertices are made as straight as practically possible. Each vertex 9 is rotatably configured in the head or in a notch 15 of a hubcap support 14 so as to be rotatable about the wire axis and there it generates the radial force required to make the hubcap 11 snap into a rim groove. FIG. 1b furthermore shows venting holes 12 in the hubcap 11.

The vertex zone 9 of the polygonal spring 1 may be a sharp point as shown in FIG. 2a, or rounded similar to the view of FIG. 2b, or with a straight section and two lateral vertices 10 as shown in FIG. 2c. Furthermore, the vertex zone 9 may comprise an inward or outward bulge 8 as shown in FIGS. 2d and 2e. In general, the vertex zone 9 may be designed in many arbitrary ways, provided that the polygonal spring in the vertex zone is supported in the hubcap support so as to be rotatable about the axis of rotation and that it is unable to move tangentially inside the support.

In case of radial spring displacement, the rotatable support makes it possible that the substantially straight connecting segments 3 may elastically bend out of the conceptual plane A of the spring from obliquely to perpendicularly to it, the polygonal spring, i.e., the wire per se, carrying out a superposed torsional motion about its axis. The angle of the oblique position depends on the geometry, for example the diameter of the polygonal spring and the number of supports along the periphery and it is in the approximate range of 45° to 85° relative to the conceptual spring plane. This elastic excursion may take place in both directions to the spring plane A as shown in FIGS. 3a, 3b and 3c. In particular, an alternating excursion as indicated in FIG. 3c also is possible. The direction of the excursion may be determined by slightly pre-bending into the desired direction or by means of an externally applied force into the central region of the straight connection element 3; only a slight deflecting force is required. Moreover, the direction of excursion also may be predetermined by externally and axially prestressing the polygonal spring.

The spring-constant line III of the radial force shown in the plot of FIG. 4 depends on the radial spring deflection and initially rises rapidly until reaching the substantially horizontal force plateau, that is, further deflection practically entails no further increase in force (=so-called constant-force behavior). Compared with the design of German Patent No. 195 01 808, which is denoted by II in FIG. 4, the constant-force behavior of the invention is even more pronounced. Accordingly, that force which is proportional to the radial force and which must be applied to remove the hubcap from the rim (so-called removing force), is substantially independent of the tolerance on the rim diameter and of the tolerances on the hubcap and the polygonal spring itself. Therefore the same hubcap may be used both for steel and aluminum strip rims that, on account of different strip thicknesses, exhibit strongly different groove diameters, incurring only slight differences in required removing force.

The invention offers another advantage, namely that the radial force exerted in the groove is comparatively very large and consequently a high hubcap rotation torque in the rim also is assured. This feature is significant so that when a rotation torque is applied to the hubcap (for instance when touching the curb stone), the valve projecting through the hubcap is endangered. This high radial force also substantially prevents the hubcap from rotating in the rim which would entail rattling motions of the antilock braking system (ABS) or the antispin regulation (ASR). Hubcap rotation in the rim causes wear at the index beaks of the hubcap supports and accordingly the hubcap would jump off the rim and might become dangerous. Comparison of the spring-constant III of the invention with the line I relating to a conventional circular spring in particular shows the considerable difference resulting in the above discussion of important differences in properties and advantage.

The polygonal spring of the invention also offers another significant advantage, namely that the same radial force as is applied in a conventional circular spring can be attained using a substantially lesser wire thickness, thereby offering lower material costs and lower weight.

The area of the valve shown schematically in cross-section in FIG. 5a is important. Within the valve area 21, the valve 25 runs from the rim 23 through an aperture 29 of the hubcap 11. FIG. 5a also shows the rim well 27 covered by the hubcap 11. The plane of the polygonal spring is denoted by A.

It is feasible henceforth to use one of the vertex zones 9 to externally or internally radially detour around the valve 25 in the plane of the polygonal spring. Both FIG. 5a and the top view of FIG. 5b show externally detouring around the valve 25 by the polygonal spring 1, a split support 14′, 14″ being configured on each side of the valve 25 as shown in FIGS. 5b and 5c. FIG. 5c also shows internally detouring around the valve 25 in that, similarly to the case shown in FIG. 2d, the polygonal spring is fitted in the vertex zone 9 with an inwardly pointing boss 8.

On the other hand, it is also possible to detour around the valve 25 radially inward by situating the polygonal spring in such a way that the valve 25 in turn is situated approximately centrally at the straight connection segment 3. Such a design solution is shown in FIG. 5d. If the polygonal spring were meant to touch the valve 25, a small additional bend 26 might also be fitted into this zone.

The connection site of the wire ends (implemented for instance by resistance butt welding or a junction bush, etc.) is advantageously situated in a vertex zone 9 because the polygonal spring is least stressed at such a location and hence the danger of deformation is least.

However, the open ends of the polygonal spring also may be connected by being inserted into blind holes of a support. FIGS. 6a and 6b show corresponding design solutions, the two wire ends 31 of the polygonal spring being inserted into corresponding blind holes of the support 14 in FIG. 6a. This solution also may be used to detour around the valve if, for instance, insufficient space is available between the rim and its well (FIGS. 5b through 5d) for the above described design solutions of radially inside or outside detouring around the valve 25. In that instance, and as shown in FIG. 6b, the wire ends 31 may be inserted into the blind holes of a split support 14′, 14″ on each side of the valve 25. In this solution, the blind holes must be configured in a manner that they shall not interfere with the polygonal spring's rotation and axial bending excursion. The support elements on each side of the valve must be connected to each other in order that they may absorb the tangential force exerted by the polygonal spring ends.

The polygonal spring also may be divided into segments while its above described operation basically remains the same. FIG. 7a illustratively shows three segments 1′ each with a bend 9 and their ends being inserted into blind holes 41 of the supports 14. The division might be just as well into two segments 1′ each with two bends 9, (not shown). Any arbitrary combination regarding the configuration of the valve 25 of FIGS. 5b through 5d and 6b may be used. All these variations comprise at least one bend 9 behaving the same way during radial spring deflection as the closed or open polygonal spring.

Without altering the basic operation of the polygonal spring, it may be divided further as shown in FIG. 7b. In that embodiment only substantially straight buckling rods are used. In this variation, however, the direction of bending upon radial spring excursion no longer is defined. If only one specified direction of bending is admissible, each buckling rod must comprise at its end a leg bend in a direction tangential to the hubcap center (FIG. 7a). In that case, the direction of bending corresponds to that of the closed or open polygonal spring, that is running axially obliquely-to-perpendicularly to the conceptual plane of the spring with superposed motion of bending and torsion. If another direction of bending is required, then it must be predetermined by the blind hole geometry 41, for example in FIG. 7d the direction of bending is radially outward or in FIG. 7e the direction of bending is radially inward. In corresponding manner, each other direction of bending also may be specified. These buckling rod variations also exhibit the above described constant-force behavior, though at a selected bend direction.

Obviously, the embodiment modes shown in FIGS. 1 through 7 of a hubcap of the invention, i.e., a wheel cover inclusive the polygonal spring of the invention are only illustrative, serving a didactic purpose. In particular the invention does not specify material selection, basically all materials known in the state of the art are applicable both when manufacturing the hubcap, i.e., the cover per se and the polygonal spring of the present invention. In other words, all known and appropriate metals and furthermore polymers or plastics may be used to manufacture the hubcap, also all suitable resilient materials and where called for reinforced plastics such as carbon-reinforced composite plastics may be used in the manufacture of the polygonal spring. Again the embodiments shown in FIGS. 1 through 7 may be altered, varied or supplemented with further features in many ways. In particular the essence of the invention is that its spring is polygonal, preferably being a regular polygon comprising preferably connecting elements as straight as possible.

1. A hubcap, i.e., a wheel cover, to be clamped onto a wheel rim (23), comprising an at least nearly closed polygonal spring (1) which is very substantially designed as an at least nearly regular polygon, characterized in that at least a portion of the vertices (9) or vertex zones of the polygonal spring (1) is affixed to radially elastic supports (14, 14′, 14″) of the hubcap (11) in order to affix the hubcap or cover (11) in a snap-in manner in an illustratively annular recess at the wheel rim, and in that the vertices or vertex zones (9) rest rotatably on the supports (14, 14′, 14″) and/or in that the polygonal spring is discontinuous at least at a portion of the vertices or vertex zones whereby, in the case of an external force applied radially to the vertices or vertex zones, there may come into being, in addition to the resulting radially inward motion of the polygonal spring (1), a further axial displacement of the polygonal spring, i.e., of the individual polygonal spring segments between the vertices or vertex zones.

2. A hubcap, i.e., a wheel cover, in particular as defined in claim 1, characterized in that the connecting elements (3, 1′, 1″) between the vertices or vertex zones (9) of the polygonal spring (1) are at least substantially straight.

3. Hubcap, i.e., a wheel cover, in particular as claimed in one of claims 1 and 2, characterized in that the polygonal spring comprises between three and ten vertices.

4. Hubcap, i.e., a wheel cover, in particular as claimed in one of claims 1 through 3, characterized in that the vertices or vertex zones (9) are sharp-pointed, rounded, or include a straight section or comprise an inward or outward pointing boss (8).

5. Hubcap, i.e., a wheel cover, in particular as claimed in one of claims 1 through 4, characterized in that the polygonal spring is pre-bent in such a way that the axial displacement caused by an external force acting on the vertices or vertex zones (9) takes place in a desired direction.

6. Hubcap, i.e., a wheel cover, in particular as claimed in one of claims 1 through 5, characterized in that the vertices or vertex zones (1) of the polygonal spring (1) or of the segments (1′, 1″) are configured in corresponding recesses or notches (15) in the head of the hubcap supports (14) so as to be rotatable about the wire axis.

7. Hubcap, i.e., a wheel cover, in particular as claimed in one of claims 1 through 6, characterized in that the polygonal spring is open at least at one vertex or vertex zone and rests by the two spring, i.e., wire, ends (31) in corresponding blind holes (41) or recesses of at least one hubcap support (14, 14′, 14″) so as to be rotatable about the wire axis.

8. Hubcap, i.e., a wheel cover, in particular as claimed in one of claims 1 through 7, characterized in that one vertex zone (9) of the polygonal spring is designed to detour on the outside or the inside of the valve (25), the hubcap support (14′, 14″) in said vertex zone preferably being at least in two parts to subtend a passage for the valve (25).

9. Hubcap, i.e., wheel cover, in particular as claimed in one of claims 1 through 8, characterized in that a straight connecting segment (3) of the polygonal spring is designed to inwardly detour around the valve (15), with an optional small radial additional bend (26) to avert touching the valve.

10. Hubcap, i.e., wheel cover, in particular as claimed in one of claims 1 through 9, characterized in that said spring consists of individual segments (1′) each fitted with at least one vertex (9), said segments' ends resting in a preferably rotatable manner in corresponding blind holes (41) or recesses of two hubcap supports.

11. Hubcap, i.e., a wheel cover, in particular as claimed in one of claims 1 through 10, characterized in that the spring consists of individual buckling rods (1″) of which the ends displaceable rest in corresponding blind holes or recesses of two adjacent hubcap supports.

12. Using the polygonal spring defined in one of claims 1 through 11 as a support spring for radial sealing rings, electrical radial contacts, radial wear compensators, etc.
